(19) United States
(12) Patent Application Publication
(10) Pub. No.: US 2023/0177525 A1
(43) Pub. Date: Jun. 8, 2023

(54) SYSTEMS AND METHODS FOR PRODUCT VERIFICATION

(71) Applicant: Dover Europe Sàrl, Vernier (CH)

(72) Inventors: Timothy Giles BEARD, Cambridge (GB); Matthew John LAWRENSON, Chesterfield, MO (US); Jan Jasper VAN DEN BERG, London (GB)

(21) Appl. No.: 17/917,350

(22) PCT Filed: Apr. 6, 2020
(86) PCT No.: PCT/EP2020/059805

§ 371 Date: Oct. 6, 2022

(51) Int. Cl. G06Q 30/018; G06K 19/06; H04L 9/00; G06V 10/62

(52) U.S. Cl. CPC G06Q 30/0185; G06K 19/06009; H04L 9/50; G06V 10/62

(57) ABSTRACT

The invention relates to a controller unit and a method, which when executed by a computer arrangement in a production line ensures validity of a product and/or product related information. The method comprises: identifying the product; printing at least a selected portion of a current block of a publicly available blockchain, said block comprising time-dependent data, which can only be determined at the time of the creation of the block on the product and product related data at production time; and storing the time-dependent data along with the unique identification for validation of the product and/or the product related information.

### TECHNICAL FIELD

The present invention relates to methods and systems for tracking, verifying and controlling authenticity of a product, product data and/or product relevant information, based on production time in general and independently verifying a time window during which the product was created in particular.

### BACKGROUND

According to EUROPOL, crimes related to counterfeit goods and products represent as much as 2.5% of world trade, or USD 461 billion (www.europol.europa.eu). “The situation in the EU is even worse: counterfeited and pirated products account for about 5% of imports to the EU. Thus, the relative impact of counterfeiting is twice as high for the developed economies of the EU as it is for the world as a whole,” continues EUROPOL.

Counterfeit related product economy is a huge economy that attracts more and more opportunists to produce all kinds of products. Rights' holders, governments and the formal economy as a whole are suffering huge losses each year, while the criminal networks that are behind the trade profit enormously. Number of counterfeit products increase every year.

Besides economic reasons, there are essential risks involved: for example, countrified medical products and food products, such as infant formula, are serious problems. It is not always the product itself that is tampered or copied but the product related information as well, such as manufacturing date, place, expiry date, best before date, content, etc., which also must be authentic for product. This information can be manipulated before or after putting the product on the market to gain economic advantageous, resulting in health and/or economic issues.

Blockchain is increasingly being used to track product traceability. Blockchain has been applied to print verification applications earlier. Public blockchain blocks contain a timestamp of approximately the time they were produced within an accuracy of a few minutes. Some data, such as the nonce or hash, generated during the formation of a block can only be determined once the block has been successfully mined and cannot be guessed in advance. Therefore, this data can be used to prove a label has not been preprinted.

In general (and not part of the invention), a blockchain is created by creating a transaction. A number of transactions are bundled together into a block, which is broadcast and approved. The approved block(s) is (are) added to the blockchain, which is shared over the network.

In some cases, it is possible to forge the time that a product is packaged, e.g. by forward-dating product expiry dates on perishable items in order to sell older goods as newer than they really are.

### SUMMARY

Consequently, there is a need to improve the process of bringing products to market and monitoring, authenticating and verifying them and simplifying the process of authentication in a secure and reliable way. Especially, the invention enhances tracking, verifying and controlling authenticity of a product, product data and/or product relevant information, based on production time in general and independently verifying a time window during which the product was created in particular. In this instance, the blockchain is being used to store data to create a blockchain-based timestamp protocol for data such as copies or images.

Advantages achieved by the present invention may include:
Preventing wrong dating: The generation of a blockchain-based timestamp upfront on production line and printing the hash (or other blockchain relevant data) on the product label to create a proof of not being pre-printed or post-printed. This also allows for increased production line speed not limited by the computing time required to generate a block in the block chain and is an important parameter when increasing the pack-rate of the packages versus the blockchain data generation.
Ability to set a desired granularity of the timestamping based on the rate at which new blocks are generated.
Ability to set the difficulty of pre-guessing the blockchain timestamp by choosing a number of characters to be printed.
Ability to simultaneously prevent pre-dating and post-dating, by storing the printed information or label information, or imaged information in a database (cloud storage, blockchain) after printing.

For these reasons, a method is provided, executed by a computer arrangement in a production line to ensure validity of a product and/or product related information, the method comprising: identifying the product; printing at least a selected portion of a current block of a publicly available blockchain, the block comprising time-dependent data, which can only be determined at the time of the creation of the block on the product and product related data at production time; and storing the time-dependent data along with the unique identification for validation of the product and/or the product related information. In one embodiment, the product is identified with a unique identification, which is at least one of a serial code, barcode, QR-code, RFID or an image. The selected portion of the current block of the publicly available blockchain may be a hash portion of the block. The method may further comprise recording an image of at least part of the product including the printed blockchain code and uploading on the same or another blockchain. In yet another embodiment the method may further comprise recording an image of at least part of the product including the printed blockchain code and storing the image. The method may also comprise: using time-dependent data; marking the product on the production line with the time-dependent data; and imaging the product during the production and storing the image in such a way that the image and a time the image was stored can be independently verified, creating a unit-specific, independently verifiable time bound during which each unique unit is produced. The time-independent data may be obtained from an independent, immutable and accessible blockchain source. The time-independent data may be characterised by one or several of: contents of data is known on creation of the data; content of data is not practical to influence; and a length of the contents is such that the probability of correctly guessing the contents is low. Preferably, the marking of the product is carried out by one or several of: a production-line coding printer; pre-printed with a unique serial code prior to production; or at production time the product is printed with the time-dependent data and production data. In one embodiment, the imaging the product is carried out by means of an imaging system by which the serial code, time-dependent data and production data are imaged. In one embodiment, the imaging is carried out at multiple stages: imaging the timed-dependent data and along with the serial code after printing it on an empty product; imaging after filling a package, print the production data and take another image.

The invention also relates to a controller unit capable of creating a mark to be printed on an object. The controller unit comprises at least a processor, a memory and a communication interface. The processor is configured to execute instructions stored in the memory to: communicate with a blockchain monitoring unit to query a blockchain source and collect data relevant to that blockchain comprising time-dependent data; obtain product relevant data about the object; generate a print code comprising a combination of the product relevant code and the blockchain time-dependent data; instruct a printer to print the print code; instruct a code processor to associate the data comprising product data and blockchain data together, along with any other relevant data; and store associated data in data storage for future validation of the product and/or the product related information. The controller unit may further be configured to: instruct an image recorder to record an image of the object with the printed code; and receive image data from the image recorder and store the recorded image. The blockchain may be freely queried in order to find a Time Variant Blockchain Data, TVBD, being data associated with the blockchain that is newly generated as time passes. The TVDB may have variable TVBD properties, including: variable time resolution based on a blockchain block generation rate; variable difficulty, wherein the probability of pre-guessing the TVDB, which may be achieved by choosing certain properties of the TVDB, such as the number of characters, the type of characters, the exact place within the blockchain where the characters are taken from and/or deduced from. This may allow for ability to set a desired granularity of the timestamping based on the rate at which new blocks are generated. The time-independent data may be characterised by one or several of: contents of data is known on creation of the data; content of data is not practical to influence; and a length of the contents is such that the probability of correctly guessing the contents is low. The controller may also be configured to instruct the image recorder to carry out image recording at multiple stages: imaging the timed-dependent data and along with the serial code after printing it on an empty product; and imaging after filling a package, print the production data and take another image. The object may comprise a unique identification, which is at least one of a serial code, barcode, QR-code, RFID or an image. The selected portion of the current block of the publicly available blockchain is a hash portion of the block.

The invention also relates to a printer comprising a mentioned controller unit.

The invention also relates to a computer comprising a controller unit as mentioned.

The invention also relates to a product production line comprising a printer or a computer as described.

### BRIEF DESCRIPTION OF THE DRAWINGS

Reference is made to the attached drawings, wherein elements having the same reference number designation may represent like elements throughout.

FIG. 1 is a diagram of an exemplary system in which methods and systems described herein may be implemented;

FIG. 2 is an exemplary printed code according to one embodiment of the present invention;

FIG. 3 is a flow diagram illustrating exemplary method steps carried out by the system of FIG. 1,

FIG. 4 is another flow diagram illustrating exemplary method steps carried out by one embodiment of the system of the present invention,

FIG. 5 is a flow diagram illustrating exemplary verifying method steps according to the present invention,

FIG. 6 illustrates a schematic product labeled in accordance with the present invention,

FIG. 7 illustrates a second example pf a product labeled in accordance with the teachings of the present invention, and

FIG. 8 illustrates schematically a controller unit according to one embodiment of the present invention.

### DETAILED DESCRIPTION

The following detailed description refers to the accompanying drawings.

The term “image” as used herein, may refer to a digital or an analog representation of visual information (e.g., a picture, a video, a photograph, animations, a set of characters or figures, etc.).

The term “cloud” as used herein, may firstly refer to a digital data storage in general and technology of distributed data processing in which some scalable information resources and capacities are provided as a service to multiple external users through Internet technology, in particular.

A term “mark” as used herein, may refer to a print applied to a specific area of an item comprising one or several types of information, such as sterilized code, barcode, product information, product identification, or any other information relevant for the product.

In addition, the following detailed description does not limit the invention. Instead, the scope of the invention is defined by the appended claims and equivalents.

Briefly, a selected portion of a current block of an available blockchain that can only be determined at the time of the creation of the block (the “time-dependent data”) is printed on a product that may include a unique identification (such as a unique serialized or serial code (letters, numbers or a combination), barcode, QR-code, RFID or an image) along with (essential) production data such as expiry date (of food, medicine, etc.), production date, batch number, etc. at the production time. Preferably, the blockchain is publicly available. In a subsequent stage, the unique serial code and the production time data are stored along with any product images captured during the production, and the blockchain code is linked to the serial code.

The printing and imaging of the time-dependent data along with the serial code and production data prevents printing production data prior to the availability of the current block of the blockchain, uniquely verifiable for each unit of production. Optionally, an image of the product and the printed blockchain code is created and uploaded on the same or another blockchain, thus providing an immutable proof that printing has exactly occurred at a given time.

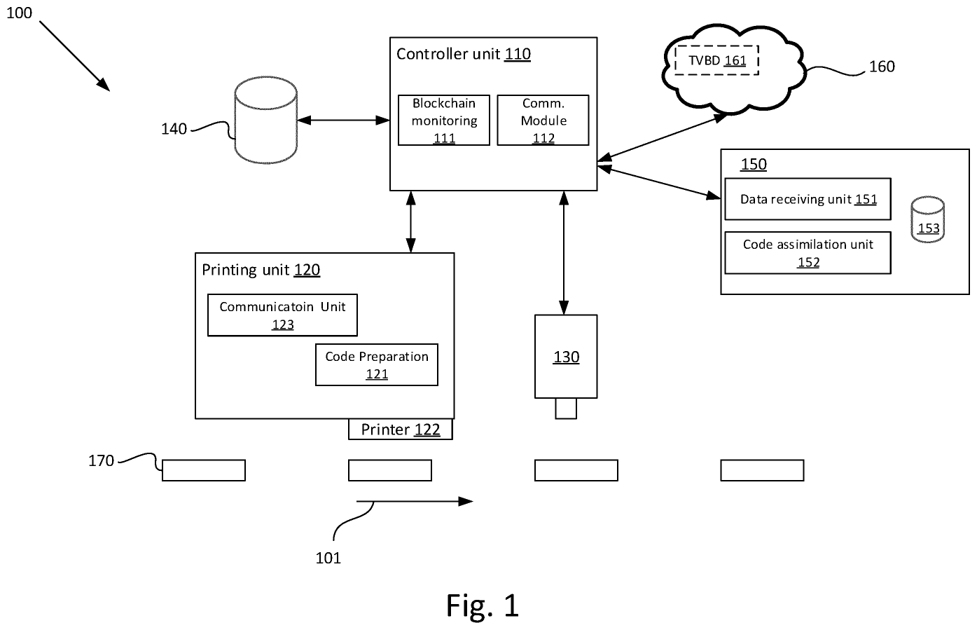

FIG. 1 is a diagram of an exemplary system 100, in which methods described herein may be implemented.

The system 100, according to this embodiment, comprises a controller unit 110, a printing unit 120, an imaging or image-recording unit (or camera) 130, a product database 140, a storage unit 150 and a blockchain source 160. According to this example, the invention is applied along a production line, such as a packaging line, in which products (objects or items) 170 pass the printing unit 120 and the imaging unit 130 in direction of the arrow 101. However, the invention may be applied in any type of production, manufacturing or assembly line in general and packaging of items or goods in particular.

The controller unit 110, which may be a standalone unit, realized as a server or part of the printing unit 120, may comprise a blockchain monitoring module 111 and a communication module 112. The blockchain monitoring module 111 is a unit capable of querying a blockchain and collecting data relevant to that blockchain from a public blockchain source 160. The communication module 112 is configured to communicate with various units and devices connected to the controller unit 110. The operation of the controller unit will be further described below.

The controller unit 110 may be in communication with a product data database 140, in which relevant product data about one or several products, is stored. The term “product data” as referred to herein, may comprise all the information about a product, which can be read, measured and structured into a usable format.

The printing unit 120 is capable of creating (or receiving print instructions) and printing a mark on the object 170. The printing unit 120 may comprise: A code preparation unit 121, a printer 122 and a communication unit 123. The printing unit may be an industrial printer using one or several of technologies: inkjet, thermal inkjet, thermal transfer, laser, small character hot melt inkjet, digital printer, etc.

The code preparation unit 121 may be capable of collecting various input data and creating a mark/print data that can then be printed. The printer 122 comprises a unit (print head) capable of transferring a mark onto the object 170 and the communication unit 123 comprises a unit capable of connecting to remote systems and establishing a communication's link.

The target object/item 170 is the object on which the mark will be printed or applied. The object 170 may comprise a pre-printed machine-readable code such as a QR-code or barcode, through which the item may be identified or through which additional product data may be accessed. The identity of the object may also be provided by an operator or detected by an image recognition detection. The object 170 may comprise a product itself, a package of the product, and/or a label, which can be applied with the print information.

The blockchain source 160 may be a ledger or database that is immutable, e.g. by being distributed over a publicly accessible peer-to-peer network, which follows a cryptographically protected consensus mechanism as to which data is added to it. The blockchain can be freely queried in order to find “Time Variant Blockchain Data (TVBD)” 161 or timestamp, being data associated with the blockchain that is newly generated as time passes. An example of TVBD is the hash code or part of the hash code that is used to validate the blockchain. The TVDB 161 may have variable “TVBD Properties,” for example:
Variable time resolution based on the generation rate of the blockchain blocks, i.e. the rate at which new transactions are immutably added to the blockchain.
Variable difficulty, meaning the probability of pre-guessing the TVDB, which may be achieved by choosing certain properties of the TVDB, such as the number of characters, the type of characters, the exact place within the blockchain where the characters are taken from and/or deduced from.

Thus, ability to set a desired granularity of the timestamping based on the rate at which new blocks are generated and ability to set the difficulty of pre-guessing the blockchain timestamp by choosing a number of characters to be printed, may be obtained.

The term “printed code” as used herein, may refer to a mark that the printer prints on the item 170 or a label applicable onto the item. The printed code may in turn contain two or more (discrete) codes:
“Code 1”: a human readable code representing various data related to the manufacture and tracking of the item (i.e. the “product data”). Optionally, the product data may itself also be stored within a blockchain. All or some of product data or product relevant data may be generated in the printer.
“Code 2”: either a human readable code, or a computer readable code, such as a barcode or QR code, that contains data relating blockchain, such as TVBD.
“Code 3”: an optional, either a human readable code or a computer readable code, such as a barcode or QR-code, for identifying the blockchain.

The imaging or image-recording unit 130 may comprise a camera with, e.g. a CMOS image sensor or other data-collecting unit, configured to obtain image data. The recorded image data being at least an image of the printed code on the item 170 or part of the item with the printed portion, just as it is being executed or after execution. It should be cleared that the marks and printed information may be entirely or partly nonvisual and when needed to be visualized, special arrangements may be used to make the marks visual.

Optionally, the data storage unit 150 may comprise:
A data receiving unit 151, which is capable of connecting to the communication unit 112 for the purpose of opening a communications channel to transmit and receive data;
A code assimilation unit 152, being a unit able to associate data such that it can be stored in a database in a way that a user may retrieve it and understand the connection between the data, i.e. for example through visual inspection detect differences in the printed information and detect fraud/miss-authentication, etc.; and/or
A code database 153, being a database that stores the various data comprising the code and any other relevant data deemed necessary and may comprise any type of data recording medium.

The data storage unit 150 may be integrated in the controller unit or arranged remotely from the controller unit 110, e.g. in so-called cloud. The data storage unit and/or its various parts may also be incorporated in the controller unit 110, which in turn may be part of the printing unit 120 or a print controller unit.

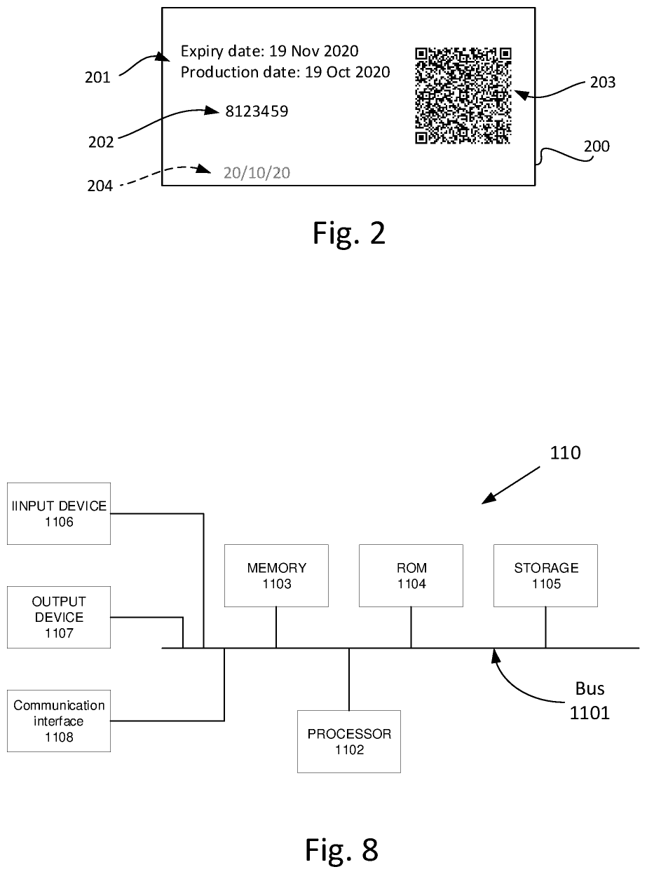

FIG. 2 illustrated an exemplary printed label 200, in accordance with one embodiment of the present invention. Code 1, 201, is product data comprising “Expiry date: 19 Nov. 2020” and “Production date: 19 Oct. 2020” of the product and Code 2, 202, information relating to the blockchain, “8123459”. A QR-code 203, e.g. for identifying the item may be pre-printed.

Optionally, additional blockchain related data (Code 3) 204 may be added to the print. The additional data may comprise, e.g. a timestamp for creation of the blockchain, or similar, for identification of the blockchain.

All or parts of the product related information may be in human readable form and/or in machine-readable form.

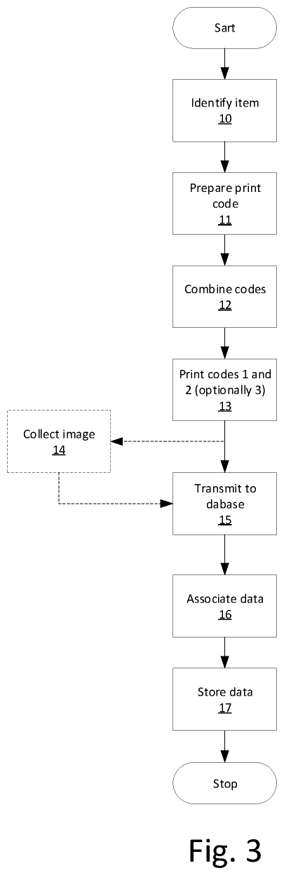

Exemplary general steps of the method of the invention according to one embodiment are illustrated in FIG. 3:
10) An item 170 to be marked is identified. The identification may be made manually, based on the preprogrammed product type, detection of the item by scanning the item, (hand) scanning data (barcode, QR-code) on the item, automatic detection with a fixed mount scanner, selection with GPIO (General Purpose Input/Output) digital inputs, selection using a data communication protocol on a serial port, e.g. Ethernet port, Real Time Ethernet, Bluetooth, WLAN, industrial serial bus, etc.
11) A print code is prepared, whereby the code preparation unit 121:
   Ascertains Code 1, 201, by querying the product data from a manufacture database;
   Ascertains Code 2, 202, by connecting to the blockchain monitoring unit 111, which then ascertains a TVBD 161 from the blockchain source 160 is obtained. Optionally, the TVBD properties may be set to a desired value in accordance with a desired time resolution and/or difficulty of the print code.

Time resolution may be based on time precision (hours, minutes, seconds, etc.) and of the blockchain generation rate and the difficulty may comprise minimum requirements for a valid hash. Other options may include define a number of uses, so that the same TVBD is not used for more than e.g. 100 codes;

12) Code 1 and Code 2 are then combined to form the print Code 1+2;
13) The printer 122 prints the Code 1+2 on the item 170; Optionally, a Code 3 may also be printed;
14) Optionally, according to one embodiment, the imaging unit 130 may collect image data (take picture of the printed area or at least part of the object including the printed area);
15) The communication module 112 may connect with the data receiving unit 151 and communicates Code 1 and Code 2 to it and/or if step 14 applied, the recorded image;
16) The code assimilation unit 152 then associates the data comprising Code 1 and Code 2 together, along with any other relevant data, which may be product data, or general data (such as time, location, etc.). Optionally, the relevant data may comprise the image data as obtained from the imaging unit 130;
17) The associated data may then be stored in the database 153 in such a way that a user can retrieve it and understand the association between the various pieces of data.

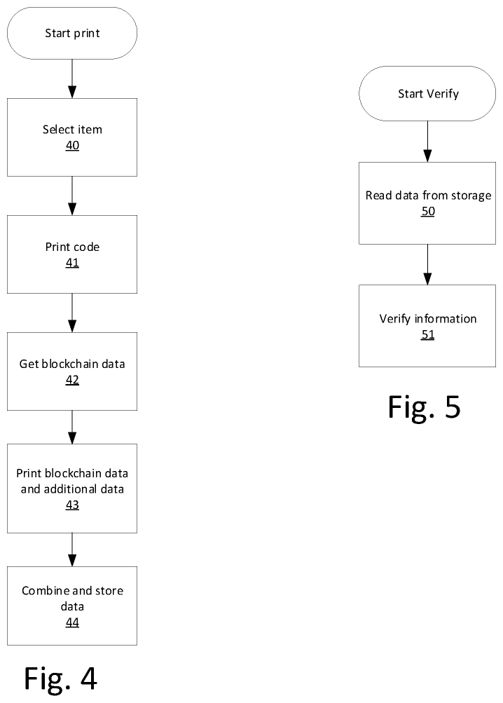

According to one embodiment, the invention may comprise the steps as illustrated in FIG. 4:
40) An item 170 is selected to be marked. The selection may be made manually, based on the preprogrammed product type, detection of the item by scanning the item, (hand) scanning data (barcode, QR-code) on the item, automatic detection with a fixed mount scanner, selection with GPIO (General Purpose Input/Output) digital inputs, selection using a data communication protocol on a serial port, e.g. Ethernet port, Real Time Ethernet, Bluetooth, WLAN, industrial serial bus, etc.
41) The Code 2 is printed on the item or a label;
42) Recent data from the blockchain is acquired;
43) Blockchain data (Code 2) together with other product data (Code 1), such as best before date, batch no., etc. is obtained; and
44) All data, i.e. Code 1 and Code 2 are combined and stored (e.g. in cloud storage). Optionally additional data from blockchain, i.e. a timestamp, may also be stored together with data. The combining data process may be performed by a service provider/server before storage or the printing unit before storing combined data.

In one embodiment, the combined data, in above-described embodiments, may also be stored in the blockchain itself.

In previously described embodiments, the verification process of the item (printed data) may include the exemplary steps illustrated in FIG. 5:
50) The user reads the QR code and print data (Code 1+2, and optionally Code 3) on the item; and
51) The user verifies the information in the publicly available blockchain and/or the data storage (e.g. cloud database) preferably independently.

By comparing the stored blockchain code against the public blockchain and finding a mismatch, it is possible to determine manipulation of the product, for example that a product was not packed at the time claimed by the manufacturer.

The inspection could also be a manual visual inspection; it could also be implemented with for example a computer solution (using a remote service) where e.g. a mobile phone or any suitable scanner scans the code, takes an image and sends the scanned code and image to a service provider/server where an OCR is performed on the production data and unique digits and compare with the stored blockchain information and if they do not match, it would be doubtful. An image comparison could also be implemented, comparing the previously described stored image with the received image to find differences. If differences are detected, the consequence is that the product and/or data are tempered. Clearly, some error margins may exist.

In an optional embodiment, the system to track a product on a production line such that it is possible to independently verify the time window during which the product is created, comprises:
A portion to read a time-dependent data from an independent, immutable and publicly accessible blockchain. The key characteristics of the data may be:
   Its contents cannot be known prior to creation of the data (e.g. creation of a blockchain block);
   It is not practical to influence the contents of the data (e.g. a blockchain nonce); and
   The length of the contents is such that the probability of correctly guessing the contents is low;
A portion, e.g. a production-line coding printer, arranged to mark the product on the production line with time-dependent data; the product may be pre-printed with a unique serial code prior to the production; at the production time, the product is printed with the time-dependent data and production/product related data;
A portion to image the product during production and record the stored image:
   Via an imaging system, the unique serial code, time-dependent data and production data are imaged, possibly at multiple stages, e.g. print the timed-dependent data on the empty product and image it along with the serial code;
   Fill the package, print the production data and take another image.
Data storing portion, in which the resulting images are stored in such a way that the images and the time they were stored can be independently verified, such as on a blockchain, thus creating a unit-specific, independently verifiable time bound during which each unique unit was produced.

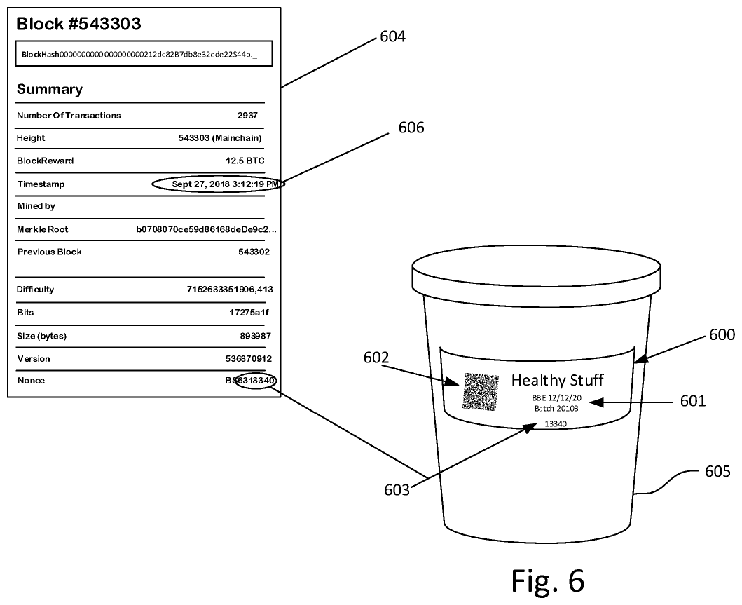

FIG. 6 illustrates a container 605, e.g. for medical substances, provided with a label 600 marked with QR-code 602, product related information 601 and blockchain data 603. The blockchain data is provided from a blockchain 604. The blockchain further comprises a timestamp 606. QR-code 602, product related information 601, blockchain data 603 and timestamp 604 from the block are stored and combined as described earlier.

For example, a rogue producer may have an excess of medical substances (or any other product, such as food (any grocery), beverage, tobacco, perishable goods, etc.) and plans to sell products with expired (past best before date or expiration date) as if they were packaged currently by deceiving previous production data. An inspector may then take a sample (e.g. product package) and look up the serial code 602 to check the claimed production date. By comparing the blockchain code 603 against the public blockchain and finding a mismatch, the inspector can determine that the product was not packed at the time claimed by the manufacturer. It should be noticed that the teachings of the invention may also be applied in areas where arbitrary expiration dates are used such as product coupons, promotional offers, credit cards, and any products with a product relevant data which can be tempered to deceive a consumer/user.

Consequently, an honest producer is incentivised to provide this data to enable them to prove the freshness of their products.

Thus, the product could not have been coded before production of the blockchain block because the unique data is not known until block is added to the blockchain. In order to validate production data subsequently serial code can be used to access stored data. Blockchain block data can be accessed independently as it is a public blockchain. If the timestamp of the blockchain's block corresponding to the printed unique code digits does not match date expected from production data then production data is suspect, e.g. forged BBE (Best Before End or best before date) dates can be identified. If the timestamp does match, then one can be confident that the stated time of production coding is correct.

The granularity of the timestamp depends on the blockchain generation rate. If Bitcoin like blockchain is used, for example, this is roughly 10 minutes. The number of digits printed determines the probability of printing the correct value by chance, e.g. 4 hex digits would give a 1 in 65 k chance. The number of digits to be printed can be selected based on the value of the products they are protecting, i.e. where the incentive to forge the production data timestamp is higher, more digits can be printed. Additionally, subsequent storage of data on a blockchain prevents it being backdated.

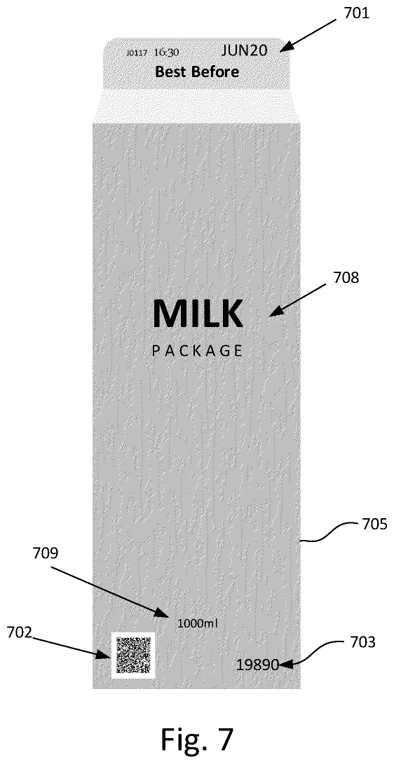

FIG. 7 illustrates another example of a product, in this case a milk package 705, provided with a number of markings: QR-code 702, product related information 701 and the blockchain data 703. The product related information 701 comprises “Best before” date “JUN20”, filling hour of the package “16:30”, and a batch number “J0117”. Other information such as product name 708 and quantity 709 may be pre-printed on the substrate when it is produced. The QR-code 702 may be pre-printed, through which the package and package content is identified or through which additional product data may be accessed. The blockchain data 703 is provided from a blockchain source. The QR-code 702, product related information 701, blockchain data 703 and timestamp from the block are stored and combined as described earlier. After production a camera may take a picture of the entire package which can be stored in the database as described earlier.

FIG. 8 is a diagram of an exemplary controller unit 110 in which methods and systems described herein may be implemented. The controller unit 110 may include a bus 1101, a processor 1102, a memory 1103, a read only memory (ROM) 1104, a storage device 1105, an input device 1106, an output device 1107, and a communication interface 1108.

The bus 1101 permits communication among the components of the controller unit 110. The controller unit 110 may also include one or more power supplies (not shown). One skilled in the art would recognize that the controller unit 110 may be configured in a number of other ways and may include other or different elements.

The processor 1102 may include any type of processor or microprocessor that interprets and executes instructions. The processor 1102 may also include logic that is able to decode instructions, image files, etc., and generate output to, for example, a speaker, a display, etc. The memory 1103 may include a random access memory (RAM) or another dynamic storage device that stores information and instructions for execution by the processor 1102. The memory 1103 may also be used to store temporary variables or other intermediate information during execution of instructions by processor 1102.

ROM 1104 may include a conventional ROM device and/or another static storage device that stores static information and instructions for the processor 1102. Storage device 1105 may include solid-state drive (SSD), a magnetic disk or optical disk and its corresponding drive and/or some other type of magnetic or optical recording medium and its corresponding drive for storing information and instructions. The storage device 1105 may also include a flash memory (e.g. an electrically erasable programmable read only memory (EEPROM)) device for storing information and instructions.

The input device 1106 may include one or more conventional mechanisms that permit a user to input information to the controller unit 110, such as a keyboard, a keypad, a directional pad, a mouse, a pen, voice recognition, a touch-screen and/or biometric mechanisms, etc. The output device 1107 may include one or more conventional mechanisms that output information to the user, including a display, a printer, one or more speakers, etc. The communication interface 1108 may include any transceiver-like mechanism that enables the controller unit 110 to communicate with other devices and/or systems. For example, communication interface 1108 may include a modem or an Ethernet interface to a LAN. Alternatively, or additionally, communication interface 1108 may include other mechanisms for communicating via a network, such as a wireless network.

The controller unit 110, consistent with the invention, provides a platform through which peripheral units and modules. The controller unit 110 may also display information associated with the executed instruction in a graphical format. According to an exemplary implementation, the controller unit 110 may perform various processes in response to processor 1102 executing sequences of instructions contained in memory 1103. Such instructions may be read into memory 1103 from another computer-readable medium, such as storage device 1105, or from a separate device via communication interface 1108. It should be understood that a computer-readable medium may include one or more memory devices or carrier waves. Execution of the sequences of instructions contained in the memory 1103 causes processor 1102 to perform the acts that will be described hereafter. In alternative embodiments, hard-wired circuitry may be used in place of or in combination with software instructions to implement aspects consistent with the invention. Thus, the invention is not limited to any specific combination of hardware circuitry and software.

The storage 1105 may store product related data. Thus, database 140 may be implemented in storage 1105. In same way, the code database 153 may be part of storage 1105.

As mentioned earlier, controller unit 110 may be part of the printer controller in the printing unit 120.

The foregoing description of embodiments of the present invention, have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

The various embodiments of the present invention described herein is described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), cloud based storage, etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

1. A computer implement method to ensure validity of one or several of a product and product related information, the method comprising:
receiving information about an identity of the product;
printing, at production time and by means of a printer, information on at least the product or a product related information carrier, a selected portion of a blockchain, the selected portion of blockchain comprising block chain time-dependent data that determines a time of creation of the blockchain; and
storing the selected portion of the blockchain, information related to product and a unique identification on the least product or product related information carrier for subsequent validation of one or several of the product or the product related information.

2. The method of claim 1, wherein the unique identification comprises at least one of a serial code, barcode, QR-code, RFID or an image.

3. The method of claim 1, wherein the selected portion of the blockchain is a hash portion of the blockchain.

4. The method of claim 1, further comprising recording an image of at least part of the product including the printed selected portion of the blockchain and the unique identification.

5. The method of claim 1, further comprising recording an image of at least part of the product including a printed blockchain code and storing the image.

6. The method of claim 1, further comprising:
imaging the product during the production and storing the image such that the image and a time the image is stored is independently verified, creating a unit-specific, independently verifiable time bound during which each unique unit is produced.

7. The method according to claim 1, wherein the selected portion of the blockchain obtained from an independent, immutable and accessible blockchain source.

8. The method according to claim 1, wherein the selected portion of the blockchain is comprised of one or several of:
content of data is known on creation of the data;
content of data is not practical to influence; and
a length of the contents is such that the probability of correctly guessing the contents is low.

9. The method according to claim 1, wherein the printing on the product is carried out by one or several of:
a production-line coding printer;
pre-printed with a unique serial code prior to production; or
at production time the product is printed with the blockchain time-dependent data and product relevant information.

10. The method according to claim 1, wherein the imaging the product is carried out by means of an imaging system by which the unique identification, the selected portion of the blockchain and the product related information are imaged.

11. The method of claim 10, wherein the imaging is carried out at multiple stages:
after printing the selected portion of the blockchain on an empty product package along with the unique identification;
after filling a package, printing product relevant information on the package.

12. A controller unit capable of creating a mark to be printed on a product, the controller unit comprising a processor, a memory and a communication interface, wherein the processor is configured to execute instructions stored in the memory to:
communicate with a blockchain monitoring unit to query a blockchain source and collect data relevant to the blockchain comprising time-dependent data;
obtain product related data about the product;
generate a print code comprising a combination of said product related data and the blockchain time-dependent data;
instruct a printer to print the print code;
instruct a code processor to associate the data comprising product related data and blockchain time-dependent data together, along with any other relevant data; and
store associated data in data storage for future validation of the product and/or product related information.

13. The controller unit of claim 12, further configured to:
instruct an image recorder to record an image of the product with said printed code; and
receive image data from said image recorder and store said image data.

14. The controller unit of claim 12, wherein a blockchain is freely queried to collect a Time Variant Blockchain Data, TVBD, being data associated with the blockchain that is newly generated as time passes.

15. The controller unit of claim 14, wherein the TVDB has variable TVBD properties, including:
variable time resolution based on a blckchain's block generation rate;
variable difficulty, wherein the probability of pre-guessing the TVDB, achievable by choosing certain properties of the TVDB, comprising one or several of a number of characters, the type of characters, the exact place within the blockchain where the characters are taken from and/or deduced from.

16. The controller unit of claim 14, wherein the blockchain time-independent data comprises one or several of:
content of data is known on creation of the data;
content of data is not practical to influence; and
a length of the contents is such that the probability of correctly guessing the contents is low.

17. The controller unit according to claim 14, configured to instruct the image recorder to carry out image recording at multiple stages:
imaging the blockchain time-dependent data along with the unique identification after printing it on an empty product package; and
imaging after filling a package, print the production data.

18-22. (canceled)
